(19) United States
(12) Patent Application Publication
(10) Pub. No.: US 2013/0132186 A1
(43) Pub. Date: May 23, 2013

(54) Methods and apparatus for processing use of a computer system

(71) Applicant: Bernd Paradies, Seattle, WA (US)

(72) Inventor: Bernd Paradies, Seattle, WA (US)

(21) Appl. No.: 11/215,598

(22) Filed: Aug. 30, 2005

(51) Int. Cl. G06Q 30/02

(52) U.S. Cl. CPC G06Q 30/0231
USPC 705/14.31

(57) ABSTRACT

A system rewards use of a software application in a computerized device during operation of the software application in the computerized device by identifying an amount of an input signal received from at least one input device in association with the software application and accumulating a total of the amount of the input signal received over time for the software application. The system provides a reward, such as airline miles or other credit, to a registered user associated with the software application based on the accumulated total of the amount of the input signal.

### BACKGROUND

Conventional computer systems operate software applications designed for interaction with users. Such software applications are commonly used to perform tasks for computer users such as web browsing, word processing and the like. The software applications are controlled by input devices, which create graphical activity on a computer display, or a graphical user interface. Conventional graphical user interfaces often provide users with a variety of mechanisms for interacting with the software application that executes within the computer. As an example, a typical graphical user interface provides the ability for a user to operate an input mechanism such as a keyboard and/or mouse or touchpad to graphically maneuver a pointing or selection mechanism, such as a cursor, within the interface in order to interact with different types of graphical constructs. Under control of the user, the mouse or touchpad provides an input signal that causes the computer to move a pointer on the graphical user interface while a keyboard is typically used to provide an alphanumeric input signal to the computer and in response, the computer displays alphanumeric characters on the graphical user interface. Conventional technologies exist that allow a user to earn rewards if that user periodically provides input into a software application such as an Internet website. For example, while using such conventional reward-for-use technologies, a user may receive credit toward a reward if the user operates a computer input device such as a mouse and/or keyboard at least once at a periodic frequency, such as once each minute, for an extended period of time while operating an active software application and/or web page. Such conventional reward-for-use technologies typically reward a user with financial incentives based on cumulative hourly usage, so that a user might receive a pre-determined financial reward for each consecutive hour of operation, so long as input was provided each minute during that hour.

### SUMMARY

Conventional technologies designed to reward a user for constant usage of a software application contain a number of drawbacks. In particular, such technologies require that a user constantly (frequently and periodically without lapse) provide input into the software program or Internet website for extended periods of time in order to obtain a reward. For example, a user of such conventional technologies may be required to provide input into a computerized device at least once every two or three minutes to ensure that the user is actively operating the software. This type of conventional technology is not ideal for a user who may wish to operate a number of software applications and/or Internet windows at one time and no on a constant basis. In such cases, such conventional technologies do not provide rewards to a user for infrequent usage. For example, a user might wish to use a software application only once every two or three hours—for five to ten minutes at a time. Using conventional reward-for-use technologies, such a user would be unable to earn credit toward a reward for such usage if the user was required to provide input constantly (e.g. once each minute) on an hourly basis.

Furthermore, conventional technologies do not reward a user for excessive usage of an application. Suppose a user operates a software program such as a graphic design workshop program. Such a user may provide a large amount of input into the application in a one or two hour period. With conventional technologies, however, the user would only be credited with a fixed reward for input provided during such a period even though the amount of use of that software was heavier than an amount of use of another software. In other words, if a user uses two programs one each minute for an hour thus qualifying for the reward, the reward provided is the same for each program, even though the amount of input provided to one program may have been much greater than the amount of input and use given to the other program during that same time.

Embodiments of the invention are designed to overcome these drawbacks and provide a different reward-for-use system that provide a tracking process that rewards users based on an amount of input signal received by a software application (or a suite of related software applications, such as all applications manufactured by a common company). Instead of rewarding a user merely based on a constant amount of input provided during incremental time periods, the current invention is designed to reward a user based on the total amount of input provided into a software application. For example, should a user operate a software application for a period of five or ten minutes, that user would be credited with a reward consistent with the total amount of input signal provided to the software in that period. By total amount of input signal, what is meant in one embodiment is an actual linear distance of movement on a graphical user interface of a cursor, pointer, or other indicator operated in response the a user controlling an input device such as a mouse or keyboard.

More specifically, the system that provides a tracking process is disclosed herein and operates to reward use of a software application during operation of the software application in the computerized device by identifying an amount of an input signal received from at least one input device in association with the software application and accumulating a total of the amount of the input signal received over time for the software application. In response, the system provides a reward to a registered user associated with the software application based on the accumulated total of the amount of the input signal. To identify an amount of an input signal received from at least one input device in association with the software application, in one embodiment the system calculates a linear distance of the input signal received from the at least one input device in association with the software application. As an example, in one configuration, in the system, the input device controls movement of a pointer (e.g. a mouse pointer or text cursor) displayed within a graphical user interface on a display of the computerized device. To calculate the linear distance of the input signal, the system measures amounts of movement of the pointer displayed within a graphical user interface to track a physical distance of movement that the pointer travels on the graphical user interface in response to operation of the input device(s). In one configuration, the system maintains a summation of measured amounts of movement of the pointer displayed within the graphical user interface to produce a total distance the pointer device travels on the graphical user interface in response to operation of the input device(s). In an alternative configuration, if the input signal is from a keyboard, the system can track an amount of text that is input. Since a user can control font size, in order to avoid a user simply increasing font size to obtain “more” linear distance as the input signal, one embodiment keeps track of a number of characters input by the user and multiplies that amount by some predetermined average length per character at a preset or predetermined font size, such as 1/12 of one inch per character, to obtain the amount of input signal, regardless of the user's actual font size setting in an application. Thus all text no matter what font size or type setting is treated as a present amount of distance per character input.

Based on the above example, the system disclosed herein processes input to a computerized device during operation of the software application in the computerized device by receiving an input signal received from at least one input device in association with the software application. In one configuration, the system applies an input weighting function based on the input signal to produce an input signal result. For example, the system determines an operation of the software application activated by the input signal and assigns a weight associated with the operation of the software application activated by the input signal to the input signal result. Successive input signals activating different operations can be assigned different weights. As an example, in one configuration, the input device can be a pointing device providing a pointing and clicking input signal such as a mouse or a keyboard providing a keystroke input signal. There may be a plurality of successive input signals received and identified from the input devices and the system adjusts the weight assigned to the input signal result based on whether the input device(s) providing the input signal is a pointing device or a keyboard device.

The system in one configuration can identify a time period between successive input signals and can adjust the weight assigned to the input signal result based on the time period elapsed since a most recent input signal that activated an operation. The system accumulates a total of the input signal result from a plurality of identified input signals and processes the total of the input signal result to produce an input signal outcome. For example, in one configuration, the system determines that total of the input signal result is accumulating faster over time and in response, adjusts operation of the software application to account for the increased faster accumulation of the input signal result. As an example, if a user is becoming more proficient at the software (hence the faster accumulating input signal), the system can adjust software application help provided to the user based on the faster accumulation of the total of the input signal result. In an alternative, based on a rate of accumulation of the total of the input signal result, the system can adjust a reward output provided to a user of the software application to reflect the faster rate of accumulation of the input signal.

In one configuration, the system provides a credit towards a reward program associated with the registered user. An amount of the credit is based on the total distance the pointer device travels on the graphical user interface in response to operation of the at least one input device. The system converts the total distance the pointer device travels on the graphical user interface to an accumulated number of travel units that are redeemable for travel in the travel reward program. The system provides a credit to the registered user for the accumulated number of travel units to allow the registered user to redeem the number of travel units for travel in the travel reward program.

In one configuration, the travel reward program is a frequent flyer program associated with at least one airline. In such an arrangement, the system converts the total distance the pointer device travels on the graphical user interface to air miles redeemable by the registered user for air travel within the frequent flyer program. In one arrangement, a certain minimum amount of accumulated distance must be traveled, such as 2000 miles, before a reward will be credited to the user. In one configuration, the system establishes a limit or maximum number of credits to be granted as credit using the system disclosed herein, so that a user cannot continue to accrue credits after reaching the limit. The maximum can be tracked in a certain time period so that, for example, no more than 2000 miles can be accumulated in one year. The limit could be reset each annual year (or other timeframe) so that in a given period of time, a user can only accrue a certain amount of credit in a given time.

Other embodiments of the invention include any type of computerized device, workstation, handheld or laptop computer, or the like configured with software and/or circuitry (e.g., a processor) to process any or all of the method operations disclosed herein. In other words, a computerized device or a processor that is programmed or configured to operate in accordance with the system as explained herein is considered an embodiment of the invention.

Other embodiments of the invention that are disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor and a display, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein.

It is to be understood that the system of the invention can be embodied strictly as a software program, as software and hardware, or as hardware alone such as within a processor, or within an operating system or a within a software application. Example embodiments of the invention may be implemented within products and/or software applications manufactured by Adobe Systems, Inc. of San Jose, Calif., USA.

### BRIEF DESCRIPTION OF THE DRAWINGS

The foregoing and other objects, features and advantages of the invention will be apparent from the following more particular description of embodiments of the invention, as illustrated in the accompanying drawings and figures in which like reference characters refer to the same parts throughout the different views. The drawings are not necessarily to scale, with emphasis instead being placed upon illustrating the embodiments, principles and concepts of the invention.

FIG. 1 is a block diagram of a computerized system configured with an application including a tracking process 150-2 in accordance with one embodiment of the invention.

FIG. 2 is a flow chart of processing steps that shows high-level processing operations performed by the tracking process 150-2 when it identifies an amount of an input signal received from at least one input device in association with the software application, in accordance with one example configuration of the invention.

FIG. 3 is a flow chart of processing steps that show the details of the tracking process 150-2 when it identifies an amount of an input signal received from at least one input device in association with the software application.

FIG. 4 is a flow chart of processing steps that show the details of the tracking process 150-2 when it provides a reward to a registered user associated with the software application based on the accumulated total of the amount of the input signal.

### DETAILED DESCRIPTION

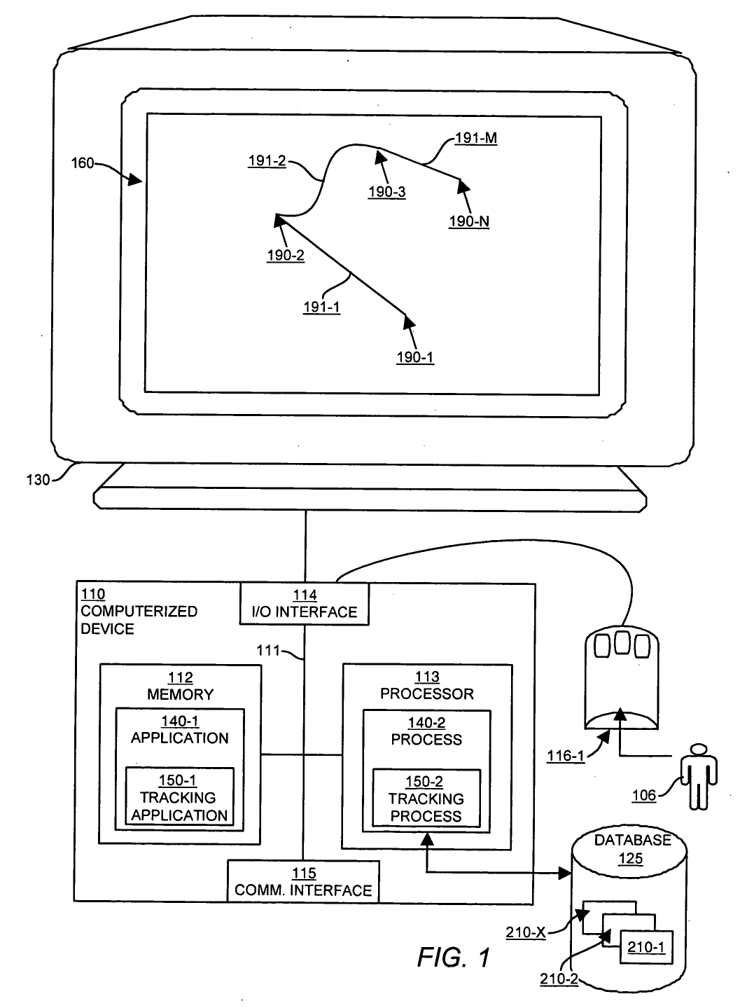

FIG. 1 is a block diagram illustrating example architecture of a computer system 110 that executes, runs, interprets, operates or otherwise performs a software application 140 and process 141 that include a tracking application 150-1 and a tracking process 150-2 configured in accordance with embodiments of the invention. The computer system 110 may be any type of computerized device such as a personal computer, workstation, portable computing device, console, laptop, network terminal or the like. As shown in this example, the computer system 110 includes an interconnection mechanism 111 such as a data bus, motherboard or other circuitry that couples a memory system 112, a processor 113, an input/output interface 114, and a communications interface 115. Input devices 116-1 through 116-W (e.g., one or more user/developer controlled devices such as a keyboard, mouse, touchpad, etc.) couples to the computer system 110 and processor 113 through an input/output (I/O) interface 114 and enables a user 108 to provide input signals and generally control a graphical user interface 160 that the application 140-1 and process 140-2 provides on the computer display 130. The communications interface 115 enables the computer system 110 to communicate with other devices (i.e., other computers) on a network such as the Internet.

The memory system 112 is any type of computer readable medium and in this example is encoded with an application 140-1 that includes a tracking process 150-2 that supports generation, display, and implementation of functional operations as explained herein. The application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of the application 140-1. Execution of application 140-1 in this manner produces processing functionality in a process 140-2. In other words, the process 140-2 represents one or more portions or runtime instances of the application 140-1 (or the entire application 140-1) performing or executing within or upon the processor 113 in the computerized device 110 at runtime.

Generally, when the software application 140 is active (i.e., is loaded and is the focus for input within the graphical user interface 160) a user 108 manipulates at least one input device 116, such as a computer mouse and/or keyboard to provide input signals 190 which can be viewed on the graphical user interface 160. For example, a user might navigate between various functions provided by the software application 140 by “dragging” a computer mouse pointer across the graphical user interface 160, providing input signals 190 (shown in this example on the graphical user interface as mouse pointer arrows 190, generally referenced as input signals) at various locations on the graphical user interface 160. In another example, a user 108 might enter input signals 190 via a keyboard in the form of text at a cursor location, which would appear onto the graphical user interface 160 as a cursor instead of a mouse pointer. As the user 108 operates the input device(s) 116, the input signals 190 move on the graphical user interface 160 some physical distance or amount. For example, between input signal locations 190-1 and 190-2, the amount moved is 191-1 (shown as a straight line). The tracking process 150-2 operates as explained herein to track the amount of the input signals 190 received on the graphical user interface 160. The tracking process 150-2 then converts the amount of the input signals 190 into a distance that is credited into a reward for a user 108.

In one embodiment, the tracking process 150-2 tracks the linear distances 191 between input signals 190 on the graphical user interface 160, and converts these distances into reward points for a user 108 of a software application. In the example in FIG. 1, the input signal locations 190-1 through 190-N represent places on the graphical user interface 160 where a mouse clicks is received, while the lines 191-1 through 191-M represent a collective or total amount of input signal received. In this example embodiment, a user 108 is rewarded points depending on the amount of the linear distances 191 accumulated. The more total linear distances 191 tracked and summed (i.e. accumulated), the more points a user 108 is rewarded.

Depending upon the specific configuration, the linear distance or total amount of input signal 191 may be a straight-line distance calculated between successive mouse clicks 190, or alternatively may be the actual distance moved across the screen, whether the movement is in a straight-line or not (such as a curved line, or random movement), as shown by the amount of input signal 191-2 that is a wavy line having some linear length if it were stretched out end to end. In other words, the total amount of accumulated input signal can be calculated differently depending on the embodiment. In one configuration, the total amount is the linear distance between successive input signals such as mouse clicks or keyboard key presses, whereas in another embodiment, the linear distance is the total physical distance the input signal representation, such as a cursor or mouse pointer travels, regardless of how many mouse clicks or keyboard key presses are received.

In one example, when the user initially installs the software application 140, the tracking process 150-2 (that may be part of the application 140, or may be a separate process) can prompt the user to determine if he or she desires to participate in reward-for-use of the software 140 based on the amount of input signal 190/191 received. If that user 108 desires to participate, the tracking process 150-2 can prompt the user 108 with a dialog box indicating what vendor rewards are available, such as, for example, by providing a list of airlines that allow amounts of input signals 190/191 into the software to be redeemable for air miles to provide reduced or no cost travel. The user can select the airline of his or her choice and can be prompted for their frequent flyer account number. The tracking process 150-2 can store this information and can use such information to print a coupon redeemable for air miles or another reward based on the amount of input signal received from that user as explained herein.

A user may be rewarded with airline frequent flier miles for usage of a software application based on the total amount of linear distance 190 that is tracked and calculated. In this example, a pre-determined formula may convert the linear distances 190 tracked and calculated by the tracking process 150-2 into an amount of airline frequent flier miles. For example, a user may be rewarded with 1 airline frequent flier mile for every one mile of linear distance 190 that the tracking process 150-2 tracks and calculates. Alternatively, a ratio may be used to scale down or scale up the amount of input signal to airline miles, such as 1/10^{th} of a mile of input signal is equal to one air mile. Using this example, a user might be awarded airline frequent flier miles based on such a pre-determined formula for operation of a software application in each period of a week, month or year.

It is noted that example configurations disclosed herein include the application 140-1 itself including the tracking process 150-2 (i.e., in the form of un-executed or non-performing logic instructions and/or data). The application 140-1 may be stored on a computer readable medium (such as a floppy disk), hard disk, electronic, magnetic, optical or other computer readable medium. The application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of the application 140-1 in the processor 113 as the process 140-2 including the tracking process 150-2. In another alternative configuration, the tracking process may be embedded in the operating system or may operate as a separate process from the application and may track all user input or only some user input (such as mouse movement or clicks, but not keyboard input). Those skilled in the art will understand that the computer system 110 may include other processes and/or software and hardware components, such as an operating system not shown in this example.

It is also noted that the display 130 need not be coupled directly to computer system 110. For example, the application 140-1 can be executed on a remotely accessible computerized device via the network interface 115 and the tracking system 150 (application and process) can be located on a client computer into which the input signals 190 are received. Calculations of total input received can be performed remotely in a distributed manner, such as on a web server. In this instance, the graphical user interface 160 may be displayed locally to a user of the remote computer and execution of the processing herein may be both client and server based.

Further details of configurations explained herein will now be provided with respect to a flow chart of processing steps that show the high level operations disclosed herein to perform the tracking process 150-2.

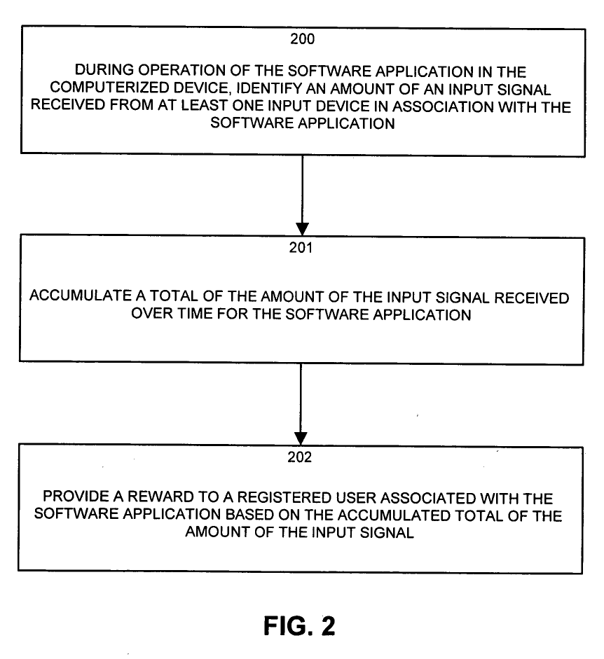

FIG. 2 is a flow chart of processing steps that shows high-level processing operations performed by the tracking process 150-2 when it identifies an amount of an input signal received from at least one input device in association with the software application, in accordance with one example configuration of the invention.

In step 200, during operation of the software application 140 in the computerized device 110, the tracking process 150-2 identifies an amount of an input signal received from at least one input device in association with the software application. As the user 108 controls one or more input devices 116, such as a computer mouse and/or keyboard, the tracking process 150-2 identifies the amount of this input signal 190/191. In one embodiment, a user 108 might navigate a software application by “dragging” a computer pointer (as shown in FIG. 1) across the graphical user interface 160, providing input signals, such as mouse clicks 190, or pointer movement events 191 (each of which creates a pointer path 191), at various locations on the graphical user interface. As the user 108 controls the input devices 116, providing input signals 190, the tracking process 150-2 identifies the amount of the input signals 190 on the graphical user interface 160.

In one embodiment, a user 108 might traverse a pre-determined coordinate plane, such as a pixel grid or map maintain in video memory, on the graphical user interface 160 by providing input via an input device 116 such as a mouse. In this embodiment, the user 108 may provide input signals 190 on the graphical user interface by “dragging” a computer pointer across such a pre-determined coordinate plane as a pixel grid. For example, a user 108 may provide one input signal 190 each time that user crosses into a new pre-determined coordinate on the graphical user interface's pixel grid. Using this example, if a graphical user interface 160 had 1000 horizontal and 1000 vertical pixel coordinates laid out on its pixel grid, a user would provide an input signal 190 each time that user 108 crossed a pre-determined coordinate (such as by moving from pixel location 20,20 to 20,21) by manipulating an input device 116 such as a mouse and/or keyboard. Thus the device driver for the input device 116 can detect each movement of the input device and this information can be passed to the tracking process 150-2 which can accumulate total distance traveled by the pointer in response to the input signal. Each pixel coordinate can have a predetermined length or distance associated with it allowing the tacking process 150-2 to sum total distance moved by the pointer or cursor.

In another embodiment, a user 108 might enter input signals 190 via a keyboard in the form of text onto a graphical user interface 160. Each keystroke that provides for movement of the cursor either up, down, right or left or diagonally (if the application 140 support diagonal cursor movement) can equate to a predetermined distance that the tracking process 150-2 can detect.

In step 201, the tracking process 150-2 accumulates a total of the amount of the input signal 190 received over time for the software application. Assume for this example description that the user provides input signals 190 on the graphical user interface by manipulating an input device 116 such as a mouse and/or keyboard. As the tracking process 150-2 identifies these input signals 190, the tracking process 150-2 accumulates the total amount of signals. In one embodiment, the tracking process 150-2 accumulates these input signals 190, such as mouse clicks, and measures the linear distances 191-M between such signals on the graphical user interface. In this example, the tracking process 150-2 may track and calculate a straight-line distance between input signals 190, such as mouse clicks. In another variation, the tracking process 150-2 may measure the actual distance of input provided by the user 108. In doing so, for example, the tracking process 150-2 might accumulate a total path-traveled distance of the path traveled by a computer pointer on the graphical user interface 160, accounting for the total linear distance moved, as opposed to solely accumulating a straight line distance between subsequent input signals 190 such as mouse clicks.

In another configuration, as a user provides input signals 190 by traversing a pre-determined coordinate plane, such as a pixel grid, on a graphical user interface, as explained previously, while the tracking process 150-2 detects and accumulates the total amount of input signals 190. In this example, the tracking process 150-2 might measure and accumulate a linear distance 191 created by adding up the total amount of input signals. As another example, each input signal 190, which is identified as a user 108 crosses a pre-determined coordinate on a coordinate grid established on the graphical user interface 160, may represent one tenth of an inch (or any other distance). Such a coordinate plane may or may not be pixel-based. By accumulating a total amount of input signals 190 provided by a user 108, the tracking process 150-2 may determine a total distance of input provided. Using this example, if user 108 traverses a total of 100 coordinates in a given period, and thus provides 100 units of input signal 190, that user would be rewarded with ten inches of total distance.

In step 202, the tracking process 150-2 provides a reward to a registered user associated with the software application based on the accumulated total of the amount of the input signal. As was explained in step 201, in one example configuration, the tracking process 150-2 identifies input signals 190 on a graphical user interface, measures the linear distances 191 between such signals, and accumulates the amount of distance. In this configuration, these linear distances 191 are converted into a reward to be credited to a registered user associated with the software application. In one configuration, a user may be rewarded with an amount of airline miles based on the total amount of linear distance 191 accumulated between input signals 190 on a graphical user interface. Assume for this example that a reward program is established that credits registered users of a software application with one airline frequent flier mile for every mile of input signal 191 provided into a computerized device. Further assume for this example that a user provides exactly one mile of input into a computerized device 110 in a given period. The tracking process 150-2 would identify, track, calculate, and accumulate this input, and would subsequently reward one airline frequent flier mile to a registered user for every one tenth of a mile of input provided. Thus, in this example, the registered user would be rewarded with ten airline frequent flier miles for the users one mile of input. Note that to avoid crediting miles at frequent intervals, in one configuration, the user must accumulate a predetermine amount of input signal distance, such as 200 miles, before they are credited with airline miles or some other reward. In this manner, the tracking process can periodically check to determine if the total accumulated input signal distance is equal to or exceeds the threshold amount required to receive the reward.

In alternate configurations, a user 108 might be credited with various other awards. Other example rewards may be monetary rewards, credit card discounts, and/or coupons based on the total amount of the input signal accumulated between input signals 190.

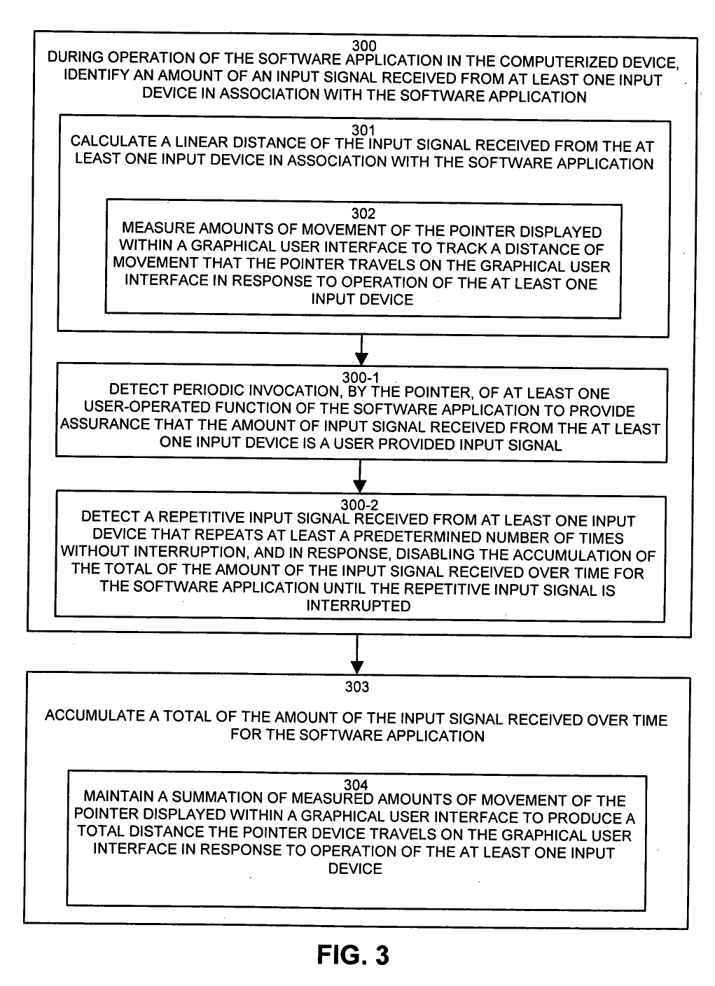

FIG. 3 is a flow chart of processing steps that show certain details of the tracking process 150-2 when it identifies an amount of an input signal 190 received from at least one input device 116 in association with the software application 140.

In step 300, during operation of the software application 140 in the computerized device 110, the tracking process 150-2 identifies an amount of an input signal received from at least one input device 116 in association with the software application 140. Steps 301, 302, 300-1 and 300-2 show certain details of this process in example embodiments.

In step 301, the tracking process 150-2 calculates a linear distance 191 of the input signal 190 received from the at least one input device 116 in association with the software application 140. In one embodiment, the user controls an input device, such as a mouse, on the graphical user interface 160. As was explained in step 201, the tracking process 150-2 identifies input signals 190 on a graphical user interface 160 and measures the linear distances 191-N between such signals. In one embodiment, the tracking process 150-2 might measure a straight-line distance between input signals 190, such as mouse clicks, on a graphical user interface 160. In another embodiment, a user 108 might traverse pre-determined coordinates on a coordinate plane, such as a pixel grid, thus providing input signals 190 into the computerized device 110. In this embodiment, the tracking process 150-2 identifies these input signals 190 and calculates a linear distance 191 of the input signal 190 received from an input device 116 in association with the software application 140.

In step 302, the tracking process 150-2 measures amounts of movement of the pointer displayed within a graphical user interface 160 to track a distance of movement that the pointer travels on the graphical user interface 160 in response to operation of the at least one input device 116. In one embodiment, the user 108 provides an input signal 190, such as a mouse click, on the graphical user interface 160 while using an input device 116, such as a mouse and the distance between mouse clicks is calculated. In another embodiment, the tracking process 150-2 tracks and measures the actual distance a pointer moves on the graphical user interface 160, as it is controlled by usage of an input device 116. For example, a user 108 may move an input device 116, such as a mouse, in a circular direction, thus creating circular motion of the mouse pointer on the graphical user interface 160. In this embodiment, the tracking process 150-2 would measure the actual distance traveled by the pointer on the graphical user interface 160, as opposed to merely measuring straight-line distances between input signals 190. Such distances can be computed by pixel events detected by the mouse device driver. The tracking process 150-2 can register with the mouse drivers as an application that requires to be notified of pixel events so that each time the mouse is moved, the location is transmitted from the mouse device driver to the tracking process 150-2 for accumulation as a distance. Each pixel event can represent some distance, such as 1/50 of an inch (assuming an approximation of 50 pixels per inch), and a running total count of pixel locations can be converted to a distance by multiplying the total pixel event representing locations that the mouse pointer has traveled to by 1/50 of an inch to get a distance. This distance can be accumulated.

Steps 300-1 and 300-2 below are optional processing operations that attempt to detect fraudulent input provided by a non-human user in an attempt to operate the application 140 to obtain the reward without the user actually using the software.

In step 300-1, the tracking process 150-2 detects periodic invocation, by the pointer, of at least one user-operated function of the software application to provide assurance that the amount of input signal received from the at least one input device is a user provided input signal. In this embodiment, step 300-1 ensures that a person is operating the input device and that a user attempting to fraudulently obtain a reward has not coupled the input device 116 to a mechanism such as a moving robotic arm to simulate human input. By requiring periodic (e.g. once every five minutes) invocation of a user-operated function, such as a pull down menu, or a button click on one of a variety of buttons, a user would have a hard time creating a robotic moving mechanism for his or her mouse that would also provide periodic invocation of a software function.

In step 300-2, the tracking process 150-2 detects a repetitive input signal received from at least one input device that repeats at least a predetermined number of times without interruption, and in response, disabling the accumulation of the total of the amount of the input signal received over time for the software application until the repetitive input signal is interrupted. In this manner, if a user is able to configure robotic operation of a keyboard or mouse and such operation is highly repetitive, such as activating the same menu choice over and over (in an attempt to overcome the functionality of step 300-1 above), the tracking process can detect this repetitive input and can disable the accumulation until the input signal becomes non-repetitive.

In step 303, the tracking process 150-2 accumulates a total of the amount of the input signal 190 received over time for the software application 140. After tracking, measuring and calculating the amount of the input signal received, the tracking process 150-2 accumulates this total over time. For example, if a number of input signals 190 are received over a period of a week, the tracking process 150-2 thus accumulates the total amount in a one-week period. The tracking process 150-2 thus accumulates a total of the amount of the input signal 190 received for any designated period of time.

In step 304, the tracking process 150-2 maintains a summation of measured amounts of movement of the pointer displayed within a graphical user interface 160 to produce a total distance the pointer device travels on the graphical user interface 160 in response to operation of the at least one input device 116. Such distance can be maintained as a numerical value representing inches, feet, miles, kilometers or some other unit.

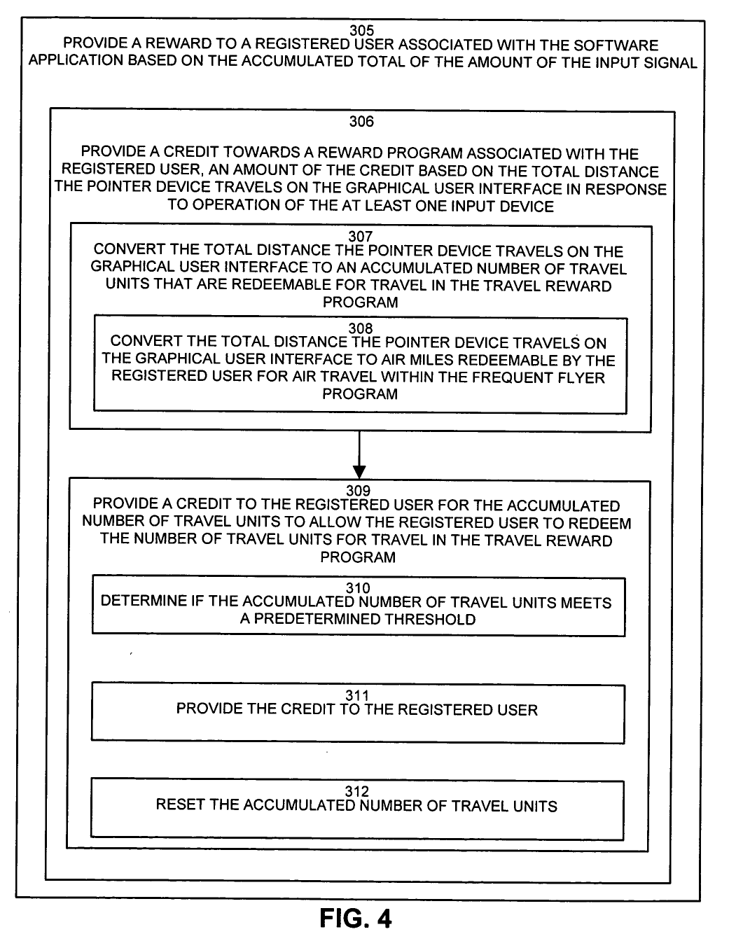

FIG. 4 is a flow chart of processing steps that show the details of the tracking process 150-2 when it provides a reward to a registered user associated with the software application 140 based on the accumulated total of the amount of the input signal 190. Steps 305, 306, 307 and 308, 309, 310, 311, and 312 show certain details of this process in example embodiments.

In step 305, the tracking process 150-2 provides a reward to a registered user associated with the software application 140 based on the accumulated total of the amount of the input signal 190. In one embodiment, a user 108 may be rewarded with a pre-determined amount of airline miles based on the total amount of accumulated input signal 190. In other example embodiments, a user 108 may be credited with monetary rewards, credit card discounts, and/or coupons based on the total amount of the input signal 190 accumulated.

In step 306, the tracking process 150-2 provides a credit towards a reward program associated with the registered user. An amount of the credit is based on the total distance the pointer device travels on the graphical user interface 160 in response to operation of the input device 116. In this configuration, the amount of the credit to a registered user increases with each pre-determined incremental increase in the distance the pointer device travels on the graphical user interface 160. Depending upon the configuration, the credit may be provided only after some threshold time or distance has been reached. As an example, the tracking process 150-2 can credit the distance every six months of use of the application 140, or may only credit the distance after a certain threshold distance has been met such as 2000 miles. The reward program can be any type of reward program and is not limited to an air miles program.

In step 307, the tracking process 150-2 converts the total distance the pointer device travels on the graphical user interface to an accumulated number of travel units that are redeemable for travel in the travel reward program.

In step 308, the tracking process 150-2 converts the total distance the pointer device travels on the graphical user interface 160 to air miles redeemable by the registered user for air travel within a frequent flyer program. Using the example from step 202, assume that a reward program is established that credits registered users of a software application with one airline frequent flier mile for every a mile of input signal provided into a computerized device. The credit can be provided to the user upon reaching a threshold amount of input, such when the user reaches 5000 miles (or any defined value). The configuration of the tracking process can be setup to credit the user only once, or can be configured to credit the user each time he or she provide another X thousand miles of input signal 191 into the software application 140.

In step 309, the tracking process 150-2 provides a credit to the registered user for the accumulated number of travel units to allow the registered user to redeem the number of travel units for travel in the travel reward program.

In step 310, the tracking process 150-2 determines if the accumulated number of travel units meets a predetermined threshold. This step allows this configuration to require that a certain amount of input signal be received before a credit is issued. In an alternative configuration, or in addition to this feature, one configuration can establish a limit or maximum number of miles to be granted as credit using the system disclosed herein, so that a user cannot continue to accrue credit after reaching the limit. The limit could be reset each annual year (or other timeframe) so that in a given year, a user can only accrue a certain amount of miles.

In step 311, the tracking process 150-2 provides the credit to the registered user.

In step 312, the tracking process 150-2 resets the accumulated number of travel units. Steps 309 through 311 can be accomplished, for example, by providing a dialog window to the user 108, upon reaching the threshold number of miles (e.g. once the user has entered 2000 miles of input signal length 191), indicating that they can print a coupon redeemable for the miles or other reward for an airline or other vendor that participates in the reward for use program.

In a system that limits the amount of credits that can accrue, the system can refuse the credit provided in step 311 if the maximum per year has been reached. In such a configuration, the system can save the date when the accrual process was started (e.g. before 310) and the accumulated miles per year (after 311) in order to determine whether the credit such as miles can still be accumulated (before 310) or if the user must wait until a new year where the accrual amount is reset to zero to allow the user to again be able to accrue input signal distance towards a credit. It is to be understood that many variations and combinations of these features can be included or not in the operational system without deviating from the spirit and scope of this invention.

While configurations of the system and method have been particularly shown and described with references to configurations thereof, it will be understood by those skilled in the art that various changes in form and details may be made therein without departing from the scope of the invention. Accordingly, the present invention is not intended to be limited by the example configurations provided above.

1. A method for processing input to a computerized device in which the computerized device accesses instructions from computer storage and executes the instructions to perform the method comprising:
during operation of a software application in the computerized device, receiving multiple input signals resulting in movement of a pointer along a first path on a graphical user interface (G.U.I.) during a first instance of a period of time, the multiple input signals received from at least one input device controlling the movement of the pointer through multiple G.U.I. locations to create the first path, each input signal requesting movement of the pointer from a current G.U.I location to a subsequent G.U.I. location;
tracking movement of the pointer through all the multiple G.U.I. locations that make up the first path to calculate a total distance from an initial G.U.I. location of the first path to a final G.U.I. location of the first path; and
providing a first credit to a registered user of the software application, an amount of the first credit based on the total distance traveled by the pointer, the first credit redeemable via a reward program.

2. The method of claim 1, comprising:
during the first instance of the period of time, receiving at least one keystroke input signal representing a character provided as text input to the software application, the keystroke input signal received from a keyboard input device coupled to the computerized device;
determining a total number of characters provided as text input from the at least one keystroke input signal;
multiplying the total number of characters by a character distance to obtain a total length of text input; and
providing a second credit to the registered user of the software application, an amount of the second credit based on the total length of text input, the second credit redeemable via the reward program.

3. The method of claim 2, comprising:
wherein providing a first credit includes: converting the total distance the pointer device travels on the G.U.I. to a first accumulated number of travel units that are redeemable for travel in a travel reward program; and
wherein providing the second credit includes: converting the total length of text input to a second accumulated number of travel units that are redeemable for travel in the travel reward program.

4. The method of claim 3, wherein the travel reward program is a frequent flyer program associated with at least one airline, and wherein converting the total distance the pointer device travels on the graphical user interface to the first number of accumulated travel units includes: converting the total distance the pointer device travels to a first amount of air miles redeemable by the registered user for air travel within the frequent flyer program; and
wherein converting the total length of text input to the second accumulated number of travel units includes: converting the total length of text input to a second amount of air miles redeemable by the registered user for air travel within the frequent flyer program.

5. (canceled)

6. The method of claim 1, comprising:
monitoring periodic invocation of at least one user-operated function provided by the software application;
determining pointer movement is associated with fraudulent input upon detecting that the at least one user-operated function has not been invoked within a specific time interval; and
upon determining pointer movement is associated with fraudulent input, disabling tracking of the movement of the pointer.

7. The method of claim 6 wherein monitoring periodic invocation includes selecting from at least one of:
(i) monitoring for selection of at least one pull down menu provided by the software application during the specific time interval; and
(ii) monitoring for selection of at least one button provided by the software application during the specific time interval.

8. The method of claim 6 wherein determining pointer movement is associated with fraudulent input includes: determining the input device is coupled to an external device simulating actual human activity.

9. The method of claim 1, comprising:
during a second instance of the period of time, tracking movement of the pointer through all multiple G.U.I. locations that make up a second path traveled by the pointer;
calculating a total distance from an initial G.U.I. location of the second path to a final G.U.I. location of the second path; and
upon determining a rate of movement of the pointer along the second path differs with respect to a rate of movement of the pointer along the first path, providing a second credit to the registered user of the software application, an amount of the second credit based on: (i) the total distance traveled by the pointer along the second path and (ii) a difference between the rate of movement of the pointer along the second path and the rate of movement of the pointer along the first path, the second credit redeemable via the reward program.

10. The method of claim 3 wherein providing the first credit to the registered user for the first accumulated number of travel units includes:
upon detecting the first accumulated number of travel units meets a predetermined threshold;
providing the first credit to the registered user; and
resetting the first accumulated number of travel units.

11. The method of claim 3 wherein providing the second credit to the registered user for the second accumulated number of travel units includes:
upon detecting the second accumulated number of travel units meets a predetermined threshold;
providing the second credit to the registered user; and
resetting the second accumulated number of travel units.

12-34. (canceled)

35. A computer readable storage medium including computer program logic encoded thereon that encodes a tracking application, that, when executed on a processor of a computerized device, wherein the computerized device provides a graphical user interface, provides a tracking process that rewards use of a software application by a user by performing operations of:
during operation of a software application in the computerized device, receiving multiple input signals resulting in movement of a pointer along a first path on a graphical user interface (G.U.I.) during a first instance of a period of time, the multiple input signals received from at least one input device controlling the movement of the pointer through multiple G.U.I. locations to create the first path, each input signal requesting movement of the pointer from a current G.U.I location to a subsequent G.U.I. location;
tracking movement of the pointer through all the multiple G.U.I. locations that make up the first path to calculate a total distance from an initial G.U.I. location of the first path to a final G.U.I. location of the first path;
providing a first credit to a registered user of the software application, an amount of the first credit based on the total distance traveled by the pointer, the first credit redeemable via a reward program.
during the first instance of the period of time, receiving at least one keystroke input signal representing a character provided as text input to the software application, the keystroke input signal received from a keyboard input device coupled to the computerized device;
determining a total number of characters provided as text input from the at least one keystroke input signal;
multiplying the total number of characters by a character distance to obtain a total length of text input; and
providing a second credit to the registered user of the software application, an amount of the second credit based on the total length of text input, the second credit redeemable via the reward program.

36. A computer system comprising:
a memory;
a processor;
a display;
an interconnection mechanism coupling the memory, the processor and the display allowing communication there between;
wherein the memory is encoded with a tracking application, that when executed in the processor, provides a tracking process that rewards use of a software application by a user by causing the computer system to perform the operations of:
during operation of a software application in the computerized device, receiving multiple input signals resulting in movement of a pointer along a first path on a graphical user interface (G.U.I.) during a first instance of a period of time, the multiple input signals received from at least one input device controlling the movement of the pointer through multiple G.U.I. locations to create the first path, each input signal requesting movement of the pointer from a current G.U.I location to a subsequent G.U.I. location;
tracking movement of the pointer through all the multiple G.U.I. locations that make up the first path to calculate a total distance from an initial G.U.I. location of the first path to a final G.U.I. location of the first path;
providing a first credit to a registered user of the software application, an amount of the first credit based on the total distance traveled by the pointer, the first credit redeemable via a reward program.

37. The computer system of claim 36, wherein the computer system further performs operations comprising:
during the first instance of the period of time, receiving at least one keystroke input signal representing a character provided as text input to the software application, the keystroke input signal received from a keyboard input device coupled to the computerized device;
determining a total number of characters provided as text input from the at least one keystroke input;
multiplying the total number of characters by a character distance to obtain a total length of text input; and
providing a second credit to the registered user of the software application, an amount of the second credit based on the total length of text input, the second credit redeemable via the reward program.

38. The computer system of claim 37, wherein the computer system further performs operations comprising:
wherein providing a first credit includes: converting the total distance the pointer device travels on the G.U.I. to a first accumulated number of travel units that are redeemable for travel in a travel reward program; and
wherein providing the second credit includes: converting the total length of text input to a second accumulated number of travel units that are redeemable for travel in the travel reward program.

39. The computer system of claim 38, wherein the travel reward program is a frequent flyer program associated with at least one airline, and wherein when the computer system performs operations converting the total distance the pointer device travels on the graphical user interface to the first number of accumulated travel units, the computer system performs operations comprising: converting the total distance the pointer device travels on the graphical user interface to the first number of accumulated travel units includes: converting the total distance the pointer device travels to a first amount of air miles redeemable by the registered user for air travel within the frequent flyer program; and
wherein when the computer system performs operations converting the total length of text input to the second accumulated number of travel units, the computer system performs operations comprising: converting the total length of text input to a second amount of air miles redeemable by the registered user for air travel within the frequent flyer program.

40. The computer system of claim 36, wherein the computer system further performs operations comprising:
monitoring periodic invocation of at least one user-operated function provided by the software application;
determining pointer movement is associated with fraudulent input upon detecting that the at least one user-operated function has not been invoked within a specific time interval; and
upon determining pointer movement is associated with fraudulent input, disabling tracking of the movement of the pointer.

41. The computer system of claim 40 wherein when the computer system performs operations monitoring periodic invocation, the computer system performs an operation comprising selecting from at least one of:
(i) monitoring for selection of at least one pull down menu provided by the software application during the specific time interval; and
(ii) monitoring for selection of at least one button provided by the software application during the specific time interval.

42. The computer system of claim 40 wherein when the computer system performs operations determining pointer movement is associated with fraudulent input, the computer system performs an operation comprising: determining the input device is coupled to an external device simulating actual human activity.

43. The computer system of claim 35, wherein the computer system further performs operations comprising:
during a second instance of the period of time, tracking movement of the pointer through all multiple G.U.I. locations that make up a second path traveled by the pointer;
calculating a total distance from an initial G.U.I. location of the second path to a final G.U.I. location of the second path; and
upon determining a rate of movement of the pointer along the second path differs with respect to a rate of movement of the pointer along the first path, providing a second credit based on: (i) the total distance traveled by the pointer along the second path and (ii) a difference between the rate of movement of the pointer along the second path and the rate of movement of the pointer along the first path, the second credit redeemable via the reward program.

44. The computer system of claim 38 wherein when the computer system performs operations providing the first credit to the registered user for the first accumulated number of travel units, the computer system performs operations comprising:
upon detecting the first accumulated number of travel units meets a predetermined threshold;
providing the first credit to the registered user; and
resetting the first accumulated number of travel units.

45. The computer system of claim 38 wherein when the computer system performs operations providing the second credit to the registered user for the second accumulated number of travel units, the computer system performs operations comprising:
upon detecting the second accumulated number of travel units meets a predetermined threshold;
providing the second credit to the registered user; and
resetting the second accumulated number of travel units.

46. The method as in claim 1, wherein tracking movement of the pointer includes: applying a first weight to at least one of the input signals received from the input device controlling movement of the pointer.

47. The method as in claim 46, the method comprising:
receiving at least one keystroke input signal representing the text input;
determining a total number of characters provided in the text input;
obtaining a total length of text input by applying a second weight to the total number of characters, the second weight different than the first weight; and
providing a second credit, to the registered user of the software application, based on the total length of text input.

48. The method as in claim 47, wherein obtaining the total length of text input includes: applying a standard character distance to the total number of characters regardless of at least one font type present in the text input.

49. The method as in claim 48, wherein providing a first credit includes:
converting the total distance the pointer device travels on the G.U.I. to a first accumulated number of travel units that are redeemable for travel in a travel reward program; and
wherein providing the second credit includes: converting the total length of text input to a second accumulated number of travel units that are redeemable for travel in the travel reward program.

50. The method as in claim 47, includes:
wherein applying the first weight includes: utilizing the first weight in response to detecting the input device controlling movement of the pointer;
wherein applying the second weight includes: utilizing the second weight due in response to receiving the at least one keystroke input signal;
wherein obtaining the total length of text input includes: applying a standard character distance to the total number of characters regardless of at least one font type present in the input text.

51. The method as in claim 1, wherein calculating the total distance includes:
calculating an amount of total distance, wherein the amount of the total distance represents receipt of each input signal from the input device.

52. The method as in claim 1, comprising:
wherein tracking movement of the pointer includes: applying a first weight to at least one of the input signals received from the input device controlling movement of the pointer, the first weight utilized upon detecting the input device controlling movement of the pointer;
wherein calculating the total distance includes: calculating an amount of the total distance, wherein the amount of the total distance represents receipt of each input signal from the input device;
the method further comprising:
receiving at least one keystroke input signal representing text input;
determining a total number of characters provided in the text input;
obtaining a total length of text input by applying (i) a second weight to the total number of characters and (ii) a standard character distance to the total number of characters regardless of at least one font type present in the text input, the second weight different than the first weight, the second weight utilized in response to receiving the at least one keystroke input signal, and
providing a second credit, to the registered user of the software, based on the total length of text input;
wherein providing the first credit includes: converting the total distance the pointer device travels on the G.U.I. to a first accumulated number of travel units that are redeemable for travel in a travel reward program; and
wherein providing the second credit includes: converting the total length of text input to a second accumulated number of travel units that are redeemable for travel in the travel reward program.
